(19) United States
(12) Patent Application Publication
(10) Pub. No.: US 2020/0078953 A1
(43) Pub. Date: Mar. 12, 2020

(54) INTELLIGENT HAIRDRESSING MACHINE AND HAIRDRESSING METHOD THEREOF

(71) Applicant: Penghui DAI, ZHUHAI (CN)

(72) Inventor: Penghui DAI, ZHUHAI (CN)

(21) Appl. No.: 16/680,361

(22) Filed: Nov. 11, 2019

Related U.S. Application Data
(63) Continuation of application No. PCT/CN2018/086251, filed on May 10, 2018.

(30) Foreign Application Priority Data
May 12, 2017 (CN) 201710333866.8

(51) Int. Cl. B25J 11/00; B26B 13/24; B26B 19/38; B25J 15/06; B25J 15/00; B25J 9/16

(52) U.S. Cl. CPC B25J 11/008; B26B 13/24; B25J 9/1679; B25J 15/0616; B25J 15/0019; B26B 19/388

(57) ABSTRACT

The present invention relates to the field of intelligent hairdressing and provides an intelligent hairdressing machine and a hairdressing method thereof. The intelligent hairdressing machine includes a head fixing apparatus, a hairdressing mechanism, a three-dimensional movement mechanism and an intelligent control unit. The hairdressing mechanism is mounted on a free end of the three-dimensional movement mechanism, the head fixing apparatus is arranged adjacent to the hairdressing mechanism, the intelligent control unit outputs a control signal to the hairdressing mechanism, and the intelligent control unit outputs a movement signal to the three-dimensional movement mechanism. The intelligent control unit controls a multi-directional movement of the three-dimensional movement mechanism, so that the hairdressing mechanism mounted on the three-dimensional movement mechanism moves in multiple directions.

### CROSS-REFERENCE TO RELATED APPLICATIONS

This application is a continuation of International Patent Application No. PCT/CN2018/086251 with a filing date of May 10, 2018, designating the United States, now pending, and further claims priority to Chinese Patent Application No. 201710333866.8 with a filing date of May 12, 2017. The content of the aforementioned applications, including any intervening amendments thereto, are incorporated herein by reference.

### BACKGROUND OF THE PRESENT INVENTION

Existing hairdressing processes are all done manually by hairdressers. Although there are a large number of hair style databases, different hairdressers are often difficult to achieve the ideal hair style effect of the customer due to greatly different hairdressing effects caused by different proficiency levels and skills. There are a limited number of hairdressers in each barber shop. In the case of more customers, there is a need to wait in line, resulting in a waste of time of the customer. In order to prevent the cut-off hair from falling into the clothes, there is a need for the customer to wear a hairdressing apron. However, the hairdressing apron is not only stuffy, but also very uncomfortable when being tied to the neck. In addition, although the customer wears the hairdressing apron, there will be hair falling on the neck, which makes the customer uncomfortable.

### SUMMARY OF PRESENT INVENTION

### Technical Problem

A main objective of the present invention is to provide an intelligent hairdressing machine that makes a customer comfortable during hairdressing and may perform automatic hairdressing operations.

Another objective of the present invention is to provide a hairdressing method of the intelligent hairdressing machine.

### Solution to Problem

### Technical Solution

In order to achieve the above main objective, the intelligent hairdressing machine provided by the present invention includes a hairdressing mechanism, a hair length control rod and an intelligent control unit. The hairdressing mechanism includes a pair of electric hairdressing scissors and a hair suction assembly. The hair suction assembly includes a vacuum pump and a suction pipe connected with the vacuum pump. The pair of electric hairdressing scissors is fixedly connected with an end portion of the suction pipe. A pair of shear bodies of the pair of electric hairdressing scissors is located outside a pipe orifice of the suction pipe. The intelligent control unit outputs a control signal to the hairdressing mechanism. A stroke measuring wheel is disposed at an end portion of the hair length control rod. The stroke measuring wheel is positioned at the same end as the pair of shear bodies. The intelligent control unit outputs a control signal to the hair length control rod according to a stroke of the stroke measuring wheel.

In a further solution, the intelligent hairdressing machine further includes a head fixing apparatus and a three-dimensional movement mechanism. The pair of electric hairdressing scissors is mounted on a free end of the three-dimensional movement mechanism. The head fixing apparatus is arranged adjacent to the hairdressing mechanism. The intelligent control unit outputs a movement signal to the three-dimensional movement mechanism.

In an alternative solution, an intelligent hairdressing machine provided by the present invention includes a hairdressing mechanism, a head fixing apparatus, a three-dimensional movement mechanism and an intelligent control unit. The hairdressing mechanism includes a pair of electric hairdressing scissors and a hair suction assembly. The hair suction assembly includes a vacuum pump and a suction pipe connected with the vacuum pump. The pair of electric hairdressing scissors is fixedly connected with an end portion of the suction pipe. A pair of shear bodies of the pair of electric hairdressing scissors is located outside a pipe orifice of the suction pipe. The intelligent control unit outputs a control signal to the hairdressing mechanism. The pair of electric hairdressing scissors is mounted on a free end of the three-dimensional movement mechanism. The head fixing apparatus is arranged adjacent to the hairdressing mechanism. The intelligent control unit outputs a movement signal to the three-dimensional movement mechanism. The head fixing apparatus includes a fixing frame and a lower jaw bracket mounted on the fixing frame. A forehead support is disposed at a top end of the fixing frame. The three-dimensional movement mechanism includes a fixing rod, a first guiding rod and a second guiding rod. A first joint is arranged between the first guiding rod and the fixing rod. A second joint is arranged between the first guiding rod and the second guiding rod. The first guiding rod is perpendicular to the second guiding rod. The pair of electric hairdressing scissors is mounted on the second guiding rod through a movable joint. Sensors are disposed at shear edges of the pair of shear bodies.

In order to achieve the above another objective, the present invention provides a hairdressing method of an intelligent hairdressing machine, including: selecting a hair style; dividing a hair area; performing hairdressing, namely, a stroke measuring wheel is clung to the scalp, a pair of electric hairdressing scissors is moved from the edge of the hair to the top of the head for hairdressing, an intelligent control unit controls extension and retraction of a hair length control rod according to a stroke of the stroke measuring wheel and a hair style function, the stroke measuring wheel leaves the scalp after arriving at the top of the head, so that the stroke is automatically cleared.

In an alternative solution, a hairdressing method of an intelligent hairdressing machine includes: selecting a hair style; fixing the head, namely, the head is fixed on a head fixing apparatus; performing hairdressing, namely, a stroke measuring wheel is clung to the scalp, a pair of electric hairdressing scissors is moved from the edge of the hair to the top of the head for hairdressing, an intelligent control unit controls extension and retraction of a hair length control rod according to a stroke of the stroke measuring wheel and a hair style function, a three-dimensional movement mechanism controls the pair of electric hairdressing scissors to move, and the pair of electric hairdressing scissors performs automatic hairdressing operations.

In another alternative solution, a hairdressing method of an intelligent hairdressing machine includes: selecting a hair style; fixing the head, namely, the head is fixed on a head fixing apparatus; measuring a head shape, namely, a head shape is selected by sensors; determining a movement trajectory of a pair of electric hairdressing scissors by an intelligent hairdressing machine according to the head shape and the selected hair style; performing hairdressing by the intelligent hairdressing machine.

### Beneficial Effects of the Present Invention

### Beneficial Effects

According to the intelligent hairdressing machine and the hairdressing method thereof provided by the present invention, the pair of electric hairdressing scissors is combined with the hair suction assembly, so that hair that is cut off is sucked away by the suction pipe, and a clean and comfortable hairdressing process is achieved. The intelligent control unit controls the extension and retraction of the hair length control rod, so that the distance between the pair of shear bodies and the scalp changes. A desired hairstyle may be obtained as long as a person controls the movement of the pair of electric hairdressing scissors, without causing an unsatisfactory hairdressing result due to the skill problem of a hairdresser.

In addition, fully-automatic hairdressing is achieved by replacing the hairdresser with the three-dimensional movement mechanism.

Moreover, the chin supports against the lower jaw bracket, and the head is stably fixed on the fixing frame, so that the fatigue of the head in a hairdressing process is reduced. The three-dimensional movement mechanism is capable of flexibly operating the hairdressing mechanism.

In addition, the hairdressing method is a semi-automatic hairdressing method, which requires manual movement of the automatic hairdressing machine. However, there is no requirement for the proficiency level of hairdressing. The intelligent control unit controls the distance between the pair of shear bodies and the scalp. A clean and comfortable hairdressing process is achieved, and the hairdressing speed is high.

Moreover, the above two hairdressing methods are fully-automatic hairdressing methods, the intelligent control unit outputs a movement signal to the three-dimensional movement mechanism, the electric hairdressing machine performs automatic hairdressing operations under the control of the intelligent control unit. Hair that is cut off is sucked away by the suction pipe, resulting in clean and comfort hairdressing without depending on the hairdresser. The intelligent hairdressing machine is high in hairdressing speed, thereby effectively resolving the difficulty caused by queues of waiting customers in peak hours.

### DESCRIPTION OF THE DRAWINGS

FIG. 1 is a schematic diagram showing a structure of an intelligent hairdressing machine according to a first embodiment of the present invention.

FIG. 2 is an operation flow diagram of a hairdressing method of an intelligent hairdressing machine according to a second embodiment of the present invention.

FIG. 3 is a schematic diagram showing a structure of an intelligent hairdressing machine according to a second embodiment of the present invention.

FIG. 4 is an enlarged diagram showing a structure of a portion A of FIG. 3.

FIG. 5 is an operation flow diagram of a hairdressing method of an intelligent hairdressing machine according to a second embodiment of the present invention.

FIG. 6 is a schematic diagram showing a structure of an intelligent hairdressing machine according to a third embodiment of the present invention.

FIG. 7 is an operation flow diagram of a hairdressing method of an intelligent hairdressing machine according to a third embodiment of the present invention.

The present invention will be further described below in conjunction with accompanying drawings and embodiments.

### DETAILED DESCRIPTION OF PREFERRED EMBODIMENTS

A first embodiment of an intelligent hairdressing machine

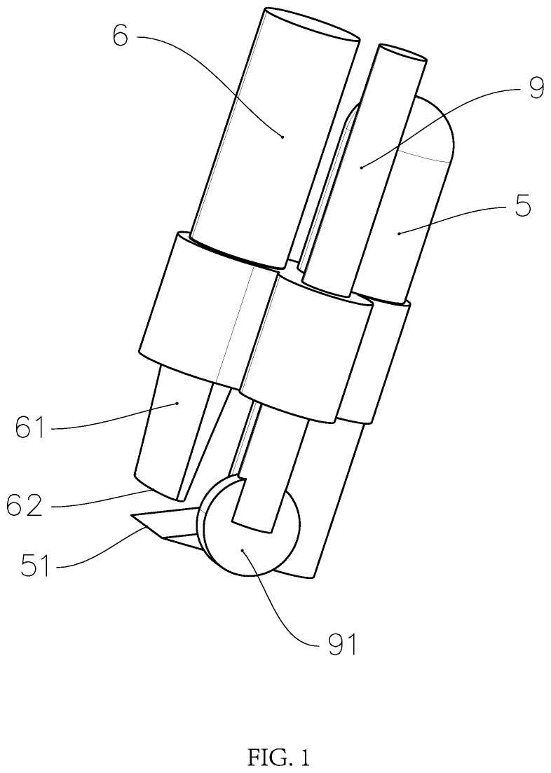

With reference to FIG. 1, FIG. 1 is a schematic diagram showing a structure of an intelligent hairdressing machine according to a first embodiment of the present invention. For the sake of brevity, parts of the structure will be omitted in FIG. 1. The intelligent hairdressing machine of the first embodiment includes a hairdressing mechanism and an intelligent control unit, wherein the hairdressing mechanism includes a pair of electric hairdressing scissors 5 and a hair suction assembly. The hair suction assembly includes a vacuum pump and a suction pipe 6. The pair of electric hairdressing scissors 5 is fixedly connected with an end portion 61 of the suction pipe 6. A structure of the vacuum pump will be omitted in FIG. 1. A pair of shear bodies 51 of the pair of electric hairdressing scissors 5 is located outside a pipe orifice 62 of the suction pipe 6. When hair is cut off, the suction pipe 6 sucks the hair. After the pair of shear bodies 51 cuts off the hair, the hair is sucked away by a hair suction apparatus without falling on the neck and clothes, so that a very clean and comfortable hairdressing is achieved.

The intelligent hairdressing machine further includes a hair length control rod 9, which is a telescopic rod. A stroke measuring wheel 91 is disposed on an end portion of the hair length control rod 9. The stroke measuring wheel 91 is located at the same end as the pair of shear bodies 51. The stroke measuring wheel 91 is arranged adjacent to the pair of shear bodies 51. The intelligent control unit may output a control signal to the hair length control rod 9 according to a stroke of the stroke measuring wheel 91, to control the extension and retraction of the hair length control rod 9.

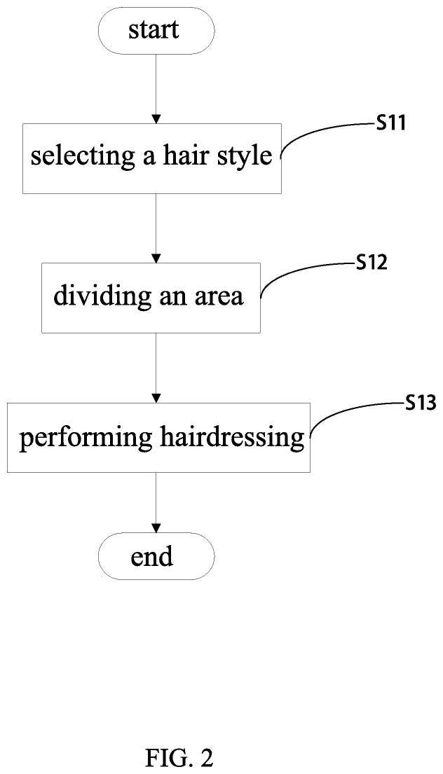

In the hairdressing method of the intelligent hairdressing machine of the first embodiment, with reference to FIG. 2, firstly, a step S11 of selecting a hair style is performed, wherein a respective hair style function corresponds to the selected hair style, and the hair style function is associated with a hair length changing curve.

Then, a step S12 of dividing a hair area is performed, namely, hair is divided into a plurality of areas, for instance, the hair may be divided into a postauricular area, a back-head area, a forehead area, and the like, and different areas are identical or different in hair style functions.

Finally, a step S13 of performing hairdressing is performed, namely, a stroke measuring wheel 91 is controlled to be clung to the scalp during hairdressing, and each time a pair of electric hairdressing scissors 5 is moved from a position on the edge of the hair to the top of the head for hairdressing, it is possible to keep bottom surfaces of a pair of shear bodies 51 parallel to the scalp in a hairdressing process, an intelligent control unit controls the extension and retraction of a hair length control rod 9 according to a stroke of the stroke measuring wheel 91 and the hair style function, thereby changing the distance between the pair of shear bodies 51 and the scalp, the stroke measuring wheel 91 leaves the scalp after arriving at the top of the head, the stroke is automatically cleared, and then the pair of electric hairdressing scissors 5 is moved to another position on the edge of the hair, and the stroke measuring wheel 91 is again moved to the top of the head for hairdressing. The step S13 is repeated until the hairdressing is finished.

This is a semi-automatic hairdressing method that requires someone to push the automatic hairdressing machine to move. Since the hair length control rod is controlled by the intelligent control unit, it is only necessary to simply push the automatic hairdressing machine from the edge of the hair to the top of the head. Anyone may become the hairdresser of the intelligent hairdressing machine. The intelligent hairdressing machine hairdressing speed is high.

A second embodiment of an intelligent hairdressing machine

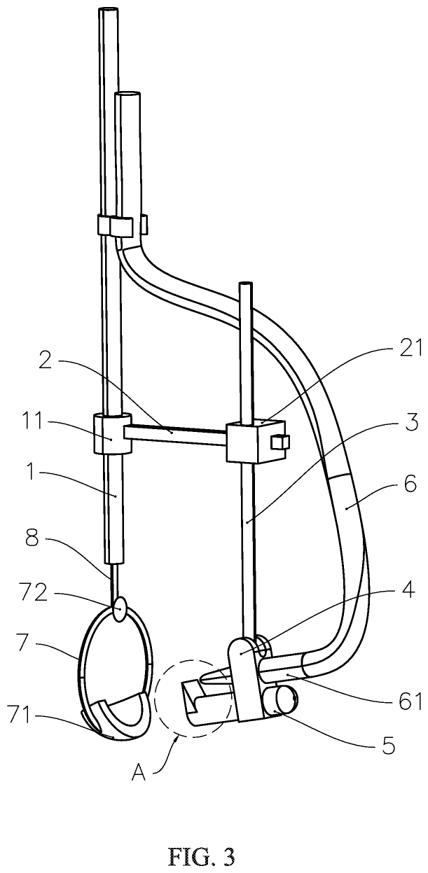

With reference to FIG. 3, FIG. 3 is a schematic diagram showing a structure of an intelligent hairdressing machine according to a second embodiment of the present invention. For the sake of brevity, a structure of an intelligent control unit and other partial structures will be omitted in FIG. 3. The intelligent hairdressing machine of the second embodiment further includes a head fixing apparatus and a three-dimensional movement mechanism. The three-dimensional movement mechanism includes a fixing rod 1, a first guiding rod 2 and a second guiding rod 3. The fixing rod 1 is a straight rod. The fixing rod 1 may be fixed on the ceiling or fixed on a wall body or ground by other fixing apparatuses. A fixing manner of the fixing rod 1 may be flexibly selected as needed. The first guiding rod 2 is connected with the fixing rod 1 through a first joint 11. In this embodiment, the first joint 11 is a horizontal rotating joint, and a gear may be arranged within the first joint so that the first guiding rod 2 rotates around the fixing rod 1 in a horizontal direction. A second joint 21 is disposed between the first guiding rod 2 and the second guiding rod 3, and a horizontal sliding rail and a vertical sliding rail are disposed on the second joint 21. The first guiding rod 2 passes through the horizontal sliding rail, and the second guiding rod 3 passes through the vertical sliding rail. A gear may be disposed within the second joint 21. Serrated racks are disposed within the first guiding rod 2 and the second guiding rod 3. The first guiding rod 2 and the second guiding rod 3 are driven by engagement of the gear and the serrated racks to move relative to the second joint 21; or the first guiding rod 2 and the second guiding rod 3 are driven by a worm and gear manner to move relative to the second joint 21. A movable joint 4 is mounted at one end of the second guiding rod 3.

The hairdressing mechanism includes a pair of electric hairdressing scissors 5 and a hair suction apparatus. The hair suction apparatus includes a vacuum pump and a suction pipe 6. The pair of electric hairdressing scissors 5 is fixedly connected with an end portion 61 of the suction pipe 6 by the movable joint 4. A structure of the vacuum pump will be omitted in FIG. 3.

The head fixing apparatus includes a fixing frame 7 and a lower jaw bracket 71 disposed on the fixing frame 7. The lower jaw bracket 71 may be fixedly or slidably sleeved on the fixing frame 7. A forehead support 72 is disposed at a top end of the fixing frame 7, and the forehead support 72 is made of a soft material and may be of a shape of a suction disc. In this embodiment, the fixing frame 7 is connected to one end of the fixing rod 1 through a connecting rod 8, and the connecting rod 8 is capable of moving up and down in the fixing rod 1. The height of the fixing frame 7 may be adjusted by adjusting the length of the connecting rod 8 according to the stature of each person. Certainly, the fixing manner of the fixing frame 7 is not limited to the above-described manner, and the fixing frame 7 may be fixed to the ground by a fixing bracket.

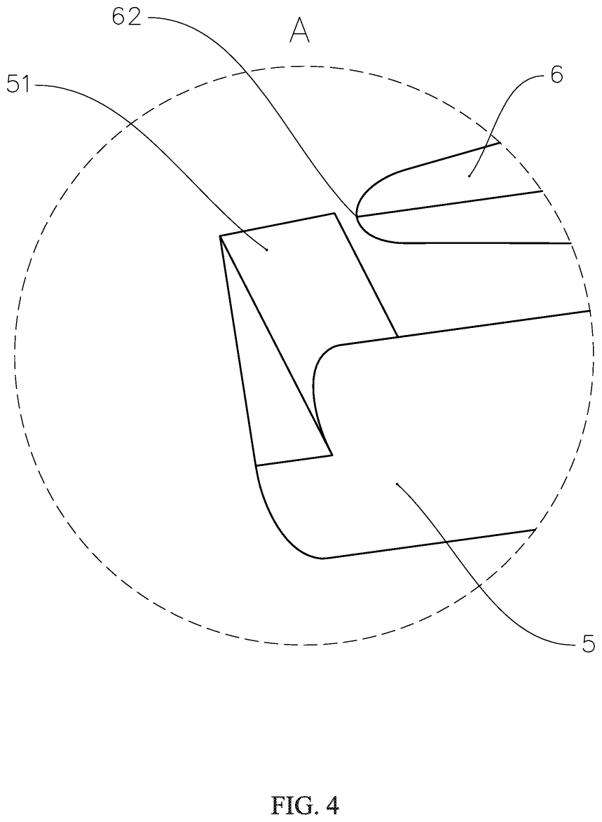

With reference to FIG. 4, FIG. 4 is an enlarged diagram of a structure of a portion A of FIG. 3. A pair of shear bodies 51 of the pair of electric hairdressing scissors 5 is located outside a pipe orifice 62 of a suction pipe 6. When hair is cut off, the suction pipe 6 sucks the hair. After the pair of shear bodies 51 cuts off the hair, the hair is sucked away by a hair suction apparatus without falling on the neck and clothes, so that a very clean and comfortable hairdressing is achieved. Sensors (not shown) are disposed at shear edges of the pair of shear bodies 51, and outer sides of the pair of shear bodies 51 refer to sides of the pair of shear bodies 51 opposite to the person's head. The rotation of the movable joint 4 may be controlled by a servo motor (not shown), such that the pair of shear bodies 51 is parallel to the scalp.

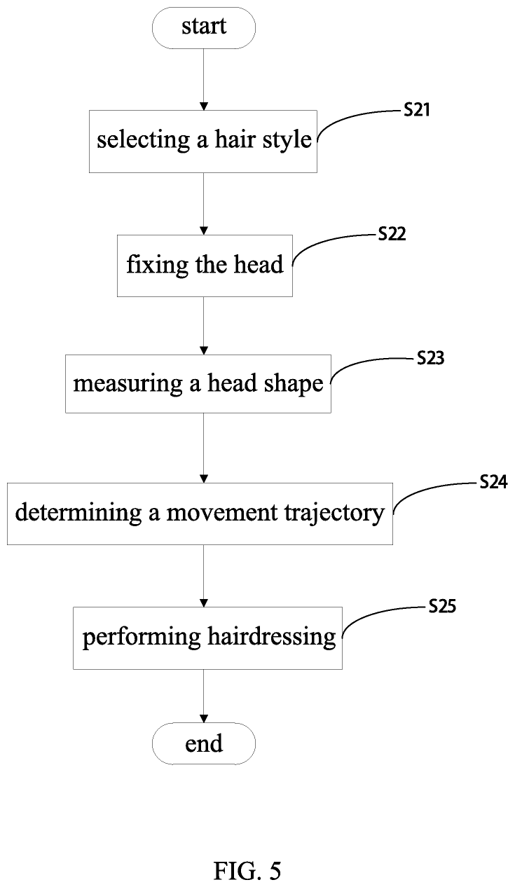

In a hairdressing method of an intelligent hairdressing machine of the second embodiment, with reference to FIG. 5, a step S21 of selecting a hair style is firstly performed, wherein a respective hair style function corresponds to the selected hair style, and the respective hair style function is associated with a hair length changing curve.

Then, a step S22 of fixing the head is performed, namely, the head is fixed on a fixing frame 7, the chin supports against a lower jaw bracket 71, and the forehead supports against a forehead support 72.

Then, a step S23 of measuring a head shape is performed, namely, key points such as the edge of the hair, the top of the head, the back of the head and ear roots on both sides of the head are measured by utilizing the sensors at front ends of the pair of shear bodies 51, so that the head shape is measured, and the scalp part may be measured according to force sensing, and the hair may be measured by means of laser according to the difference in light reflectivity of the scalp and the hair. The measured data is more accurate due to the fixation of the head.

Then, a step S24 of determining a movement trajectory is performed, namely, the movement trajectory of a hairdressing mechanism is determined according to a hair style function and in combination the data of the head shape, that is, the movement trajectory of the pair of electric hairdressing scissors is determined.

Finally, a step S25 of performing hairdressing is performed, namely, the pair of electric hairdressing scissors 5 performs hairdressing operations according to the movement trajectory, the intelligent control unit outputs a control signal to the hairdressing mechanism, and the intelligent control unit outputs a movement signal to the three-dimensional movement mechanism, and it is possible to keep a pair of shear bodies 51 parallel to the scalp in the hairdressing process until the hairdressing is finished.

The hairdressing method is a fully-automatic hairdressing method. All the steps are automatically completed by the intelligent hairdressing machine under the control of the intelligent control unit without depending on the hairdresser. The intelligent hairdressing machine is high in hairdressing speed, thereby effectively resolving the difficulty caused by queues of waiting customers in peak hours. The intelligent hairdressing machine is clean in hairdressing process without causing the hair to fall on the neck and clothes.

A third embodiment of an intelligent hairdressing machine

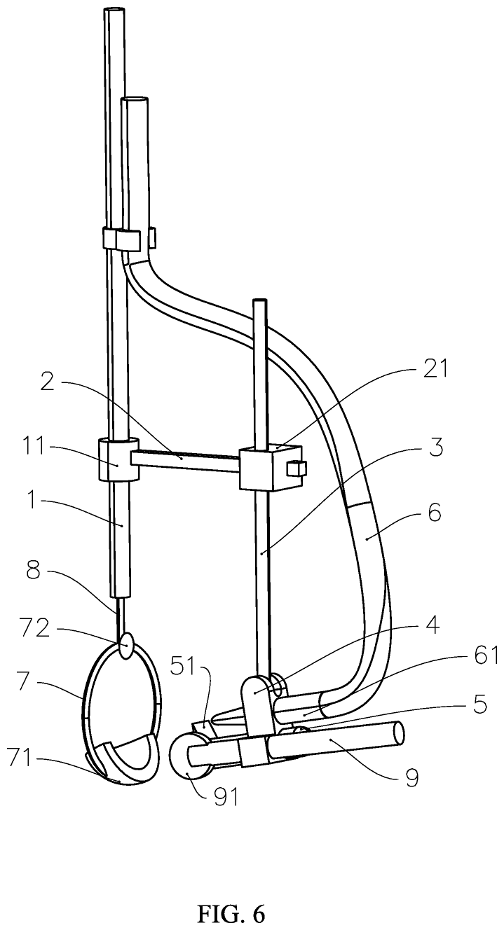

With reference to FIG. 6, FIG. 6 is a schematic diagram showing a structure of an intelligent hairdressing machine according to a third embodiment of the present invention. For the sake of brevity, a structure of an intelligent control unit and other partial structures will be omitted in FIG. 6. A head fixing apparatus and a three-dimensional movement mechanism of the intelligent hairdressing machine of the third embodiment are the same as those of the second embodiment. A hair length control rod 9 adjacent to a pair of electric hairdressing scissors is mounted on a movable joint 4. A stroke measuring wheel 91 is disposed on an end portion of the hair length control rod 9. The stroke measuring wheel 91 is disposed in parallel with a pair of shear bodies 51. The intelligent control unit outputs a control signal to the hair length control rod 9, to control the extension and retraction of the hair length control rod 9.

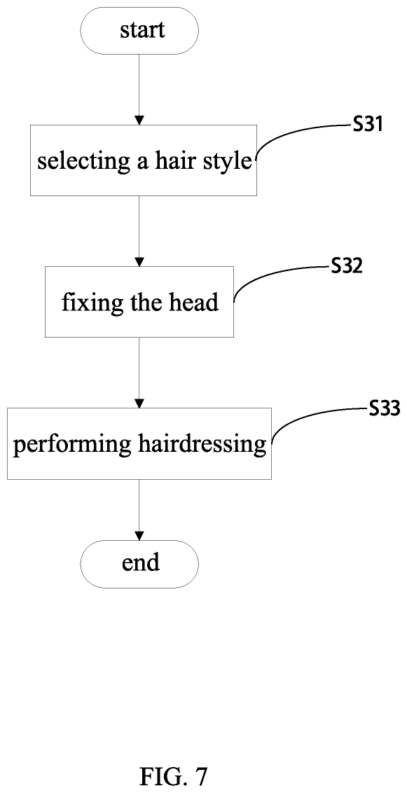

In a hairdressing method of an intelligent hairdressing machine of the third embodiment, with reference to FIG. 7, a step S31 of selecting a hair style is firstly performed, wherein a respective hair style function corresponds to the selected hair style, and the respective hair style function is associated with a hair length changing curve.

Then, a step S32 of fixing the head is performed, namely, the head is fixed on a fixing frame 7, the chin supports against a lower jaw bracket 71, and the forehead supports against a forehead support 72.

Finally, a step S33 of performing hairdressing is performed, namely, a stroke measuring wheel 91 is clung to the scalp, and the stroke measuring wheel 91 determines a position of a pair of electric hairdressing scissors. Each time the pair of electric hairdressing scissors 5 is moved from the edge of the hair to the top of the head for hairdressing, the intelligent control unit controls the extension and retraction of the hair length control rod 9 according to a stroke of the stroke measuring wheel 91 and the hair style function, thereby changing the distance between the pair of shear bodies 51 and the scalp. The stroke measuring wheel 91 leaves the scalp after arriving at the top of the head, and the stroke is automatically cleared. A three-dimensional movement mechanism controls the pair of electric hairdressing scissors 5 to move. The pair of electric hairdressing scissors 5 performs automatic hairdressing operations. In the hairdressing process, the suction pipe 6 straightens the hair, and hair that is cut off is sucked away by the suction pipe. It is possible to keep the pair of shear bodies 51 parallel to the scalp in the hairdressing process.

The hairdressing method differs from the hairdressing method of the intelligent hairdressing machine of the first embodiment in that the three-dimensional movement mechanism is equivalent to a human hand to control the movement of the hairdressing machine. The hairdressing method is a fully-automatic hairdressing method as well.

Certainly, the above embodiments are merely preferred embodiments of the present invention, and there may be more changes in practical applications. For example, the first joint of the three-dimensional movement mechanism may be rotated not only in the horizontal direction, but also moved up and down; or both the first guiding rod and the second guiding rod are telescope guiding rods, and the extension and retraction of the first guiding rod and the second guiding rod are controlled by a cylinder or the like. These changes may achieve the objectives of the present invention as well. Any modifications, equivalents, improvements, etc. made within the spirit and principle of the present invention should be included within the scope of protection of the claims of the present invention.

### INDUSTRIAL APPLICABILITY

The intelligent hairdressing machine and the hairdressing method thereof are suitable for use in hairdressing. Automatic or semi-automatic hairdressing is achieved by applying the intelligent hairdressing machine and the hairdressing method thereof of the present invention.

I claim:

1. An intelligent hairdressing machine, comprising:
a hairdressing mechanism, a hair length control rod and an intelligent control unit, wherein the hairdressing mechanism comprises a pair of electric hairdressing scissors and a hair suction assembly, the hair suction assembly comprises a vacuum pump and a suction pipe connected with the vacuum pump, the pair of electric hairdressing scissors is fixedly connected with an end portion of the suction pipe, a pair of shear bodies of the pair of electric hairdressing scissors is located outside a pipe orifice of the suction pipe, the intelligent control unit outputs a control signal to the hairdressing mechanism; and
a stroke measuring wheel is disposed at an end portion of the hair length control rod, and the stroke measuring wheel and is positioned at the same end as the pair of shear bodies, and the intelligent control unit outputs a control signal to the hair length control rod according to a stroke of the stroke measuring wheel.

2. The intelligent hairdressing machine according to claim 1, further comprising:
a head fixing apparatus and a three-dimensional movement mechanism, wherein the pair of electric hairdressing scissors is mounted on a free end of the three-dimensional movement mechanism, the head fixing apparatus is arranged adjacent to the hairdressing mechanism, and the intelligent control unit outputs a movement signal to the three-dimensional movement mechanism.

3. The intelligent hairdressing machine according to claim 1, further comprising:
a hairdressing mechanism, a head fixing apparatus, a three-dimensional movement mechanism and an intelligent control unit, wherein the hairdressing mechanism comprises a pair of electric hairdressing scissors and a hair suction assembly; the hair suction assembly comprises a vacuum pump and a suction pipe connected with the vacuum pump; the pair of electric hairdressing scissors is fixedly connected with an end portion of the suction pipe, a pair of shear bodies of the pair of electric hairdressing scissors is located outside a pipe orifice of the suction pipe, the intelligent control unit outputs a control signal to the hairdressing mechanism; and
the pair of electric hairdressing scissors is mounted on a free end of the three-dimensional movement mechanism, the head fixing apparatus is arranged adjacent to the hairdressing mechanism, and the intelligent control unit outputs a movement signal to the three-dimensional movement mechanism.

4. The intelligent hairdressing machine according to claim 3, wherein
the head fixing apparatus comprises a fixing frame and a lower jaw bracket mounted on the fixing frame, and a forehead support is disposed at a top end of the fixing frame.

5. The intelligent hairdressing machine according to claim 3, wherein
the three-dimensional movement mechanism comprises a fixing rod, a first guiding rod and a second guiding rod, a first joint is arranged between the first guiding rod and the fixing rod, and a second joint is arranged between the first guiding rod and the second guiding rod, the first guiding rod is perpendicular to the second guiding rod, and the pair of electric hairdressing scissors is mounted on the second guiding rod through a movable joint.

6. The intelligent hairdressing machine according to claim 5, wherein
sensors are disposed at shear edges of the pair of shear bodies.

7. A hairdressing method of an intelligent hairdressing machine, wherein
the intelligent hairdressing machine employs the intelligent hairdressing machine according to claim 1,
the hairdressing method comprises:
selecting a hair style;
dividing a hair area;
hairdressing, namely, a stroke measuring wheel is clung to the scalp, a pair of electric hairdressing scissors is moved from the edge of the hair to the top of the head for hairdressing, an intelligent control unit controls the extension and retraction of a hair length control rod according to a stroke of the stroke measuring wheel and a hair style function, the stroke measuring wheel leaves the scalp after arriving at the top of the head, so that the stroke is automatically cleared.

8. A hairdressing method of an intelligent hairdressing machine, wherein
the intelligent hairdressing machine employs the intelligent hairdressing machine according to claim 2,
the hairdressing method comprises:
selecting a hair style;
fixing the head, namely, the head is fixed on the head fixing apparatus;
performing hairdressing, namely, a stroke measuring wheel is clung to the scalp, a pair of electric hairdressing scissors is moved from the edge of the hair to the top of the head for hairdressing, an intelligent control unit controls the extension and retraction of a hair length control rod by according to a stroke of the stroke measuring wheel and a hair style function, a three-dimensional movement mechanism controls the pair of electric hairdressing scissors to move, and the pair of electric hairdressing scissors performs automatic hairdressing operations.

9. A hairdressing method of an intelligent hairdressing machine, wherein
the intelligent hairdressing machine employs the intelligent hairdressing machine according to claim 6,
the hairdressing method comprises:
selecting a hair style;
fixing the head, namely, the head is fixed on the head fixing apparatus;
measuring a head shape, namely, the head shape is measured by sensors;
determining a movement trajectory of a pair of electric hairdressing scissors by the intelligent hairdressing machine according to the head shape and the selected hair style; and
performing hairdressing by the intelligent hairdressing machine.
